(19) United States
(12) Patent Application Publication
(10) Pub. No.: US 2026/0072395 A1
(43) Pub. Date: Mar. 12, 2026

(54) IMAGE FORMING APPARATUS

(71) Applicant: CANON KABUSHIKI KAISHA, Tokyo (JP)

(72) Inventor: TOSHIHIDE SHIMA, Chiba (JP)

(21) Appl. No.: 19/318,561

(22) Filed: Sep. 4, 2025

(30) Foreign Application Priority Data
Sep. 9, 2024 (JP) 2024-154760

(51) Int. Cl. G03G 21/16; G03G 15/00

(52) U.S. Cl. CPC G03G 21/1647; G03G 15/6511; G03G 2215/00383; G03G 2221/1654

(57) ABSTRACT

An image forming apparatus configured to form an image on a recording material includes a first casing, a second casing connected to the first casing in a vertical direction, a positioning projection provided to the first casing, and a fitted portion provided to the second casing, the positioning projection fitting to the fitted portion. The fitted portion is formed to allow relative sliding movement between the positioning projection and the second casing in a first direction intersecting the vertical direction and to limit a range of relative movement between the positioning projection and the second casing in a second direction intersecting the vertical direction and the first direction when the first casing and the second casing being connected to each other.

### BACKGROUND

### Field of the Technology

The present disclosure relates to an image forming apparatus such as a printer, a copier, a facsimile machine, or a multifunction peripheral.

### Description of the Related Art

In an image forming apparatus forming an image on a recording material, such a configuration is proposed that plural casings installed with various units are stacked vertically. A series of operations related to image formation on the recording material is implemented by the various units installed in the plural casings, respectively. For example, a sheet feeding apparatus is connected to a lower side of an image forming apparatus body (hereinafter, simply referred as an apparatus body). The apparatus body has a casing in which an image forming device configured to form an image on the recording material is installed. The sheet feeding apparatus has a different casing in which a cassette storing the recording material, a supply unit configured to supply the recording material in the cassette to the apparatus body, and the like are installed.

In order to attach the sheet feeding apparatus to the apparatus body, a worker lifts the apparatus body over the sheet feeding apparatus and places the apparatus body on the sheet feeding apparatus. At the time, the worker disposes the casing of the apparatus body and the casing of the sheet feeding apparatus at a predetermined relative position. For this reason, a positioning hole and a positioning pin are respectively provided to the casing of the apparatus body and the casing of the sheet feeding apparatus. In Japanese Patent Application Laid-Open Publication No. 2021-31275, a sheet feeding apparatus further including an additional positioning member is disclosed. With lowering of the lifted apparatus body onto the sheet feeding apparatus from above, the auxiliary positioning member guides a lower end frame of the apparatus body such that the positioning hole provided to the lower end frame is fitted to the positioning pin provided to an upper end frame of the sheet feeding apparatus.

However, even in a case where the auxiliary positioning member described above is adopted, the worker still has to align the casing of the apparatus body and the casing of the sheet feeding apparatus in a horizontal direction while lowering the lifted apparatus body from above onto the sheet feeding apparatus below. Therefore, in the hitherto known art, it is difficult to perform work of connecting the plural casings at the predetermined relative position.

### SUMMARY

The present disclosure provides an image forming apparatus configured such that a worker can easily align a first casing and a second casing.

According to a first aspect of the present disclosure, an image forming apparatus configured to form an image on a recording material includes a first casing, a second casing connected to the first casing in a vertical direction, a positioning projection provided to the first casing, and a fitted portion provided to the second casing, the positioning projection fitting to the fitted portion. The fitted portion is formed to allow relative sliding movement between the positioning projection and the second casing in a first direction intersecting the vertical direction and to limit a range of relative movement between the positioning projection and the second casing in a second direction intersecting the vertical direction and the first direction when the first casing and the second casing being connected to each other.

According to a second aspect of the present disclosure, an image forming apparatus configured to form an image on a recording material, the image forming apparatus includes a first casing, a second casing connected to the first casing in a vertical direction, a positioning projection provided to the first casing, and a fitted portion provided to the second casing and configured to be fitted to the positioning projection. The fitted portion includes a groove portion that extends in the first direction intersecting the vertical direction and in which the positioning projection is inserted. In a state where the positioning projection is inserted in the groove portion, a first range where the positioning projection can move in the first direction is greater than a second range where the positioning projection can move in a second direction intersecting the vertical direction and the first direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view illustrating an image forming apparatus according to the present embodiment.

FIG. 2 is a perspective view illustrating the image forming apparatus in a state where an apparatus body and a sheet feeding apparatus are separated from each other.

FIG. 3A is a perspective view illustrating the sheet feeding apparatus seen from above.

FIG. 3B is a perspective view illustrating the apparatus body seen from below.

FIG. 4 is an enlarged view illustrating a positioning member.

FIG. 5 is a schematic view illustrating the positioning member, a positioning projection, and a projecting portion.

FIG. 6A is a view illustrating a state before alignment work.

FIG. 6B is a view illustrating a state during the alignment work.

FIG. 6C is a view illustrating a state after the alignment work.

FIG. 7 is a side cross-sectional view illustrating positions of the positioning projection and the projecting portion with respect to the positioning member.

FIG. 8A is a schematic view illustrating a state where a projecting portion of the apparatus body and a projecting portion of the sheet feeding apparatus abut each other.

FIG. 8B is a schematic view illustrating a state immediately before the abutment between the projecting portion of the apparatus body and the projecting portion of the sheet feeding apparatus is canceled.

FIG. 8C is a schematic view illustrating a state where the projecting portion of the apparatus body and the projecting portion of the sheet feeding apparatus do not abut each other.

FIG. 9 is a schematic view illustrating the positioning member, the positioning projection, and the projecting portion in a case where an attachment direction is from front to rear.

FIG. 10 is a schematic view illustrating the positioning member and the positioning projection in a configuration not including the projecting portion.

### DESCRIPTION OF THE EMBODIMENTS

### Image Forming Apparatus

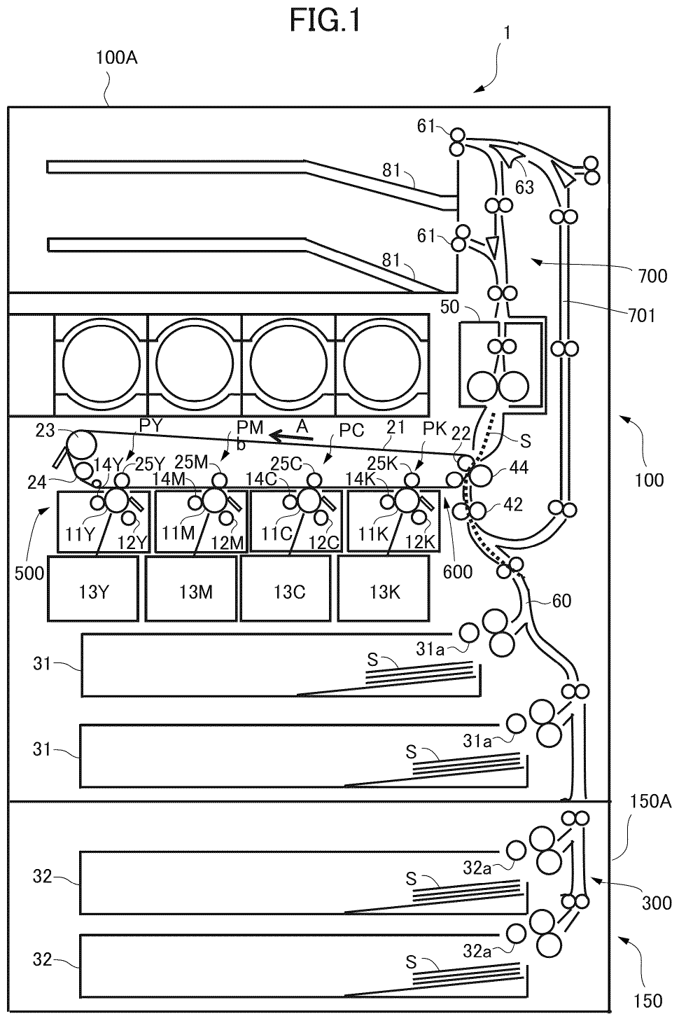

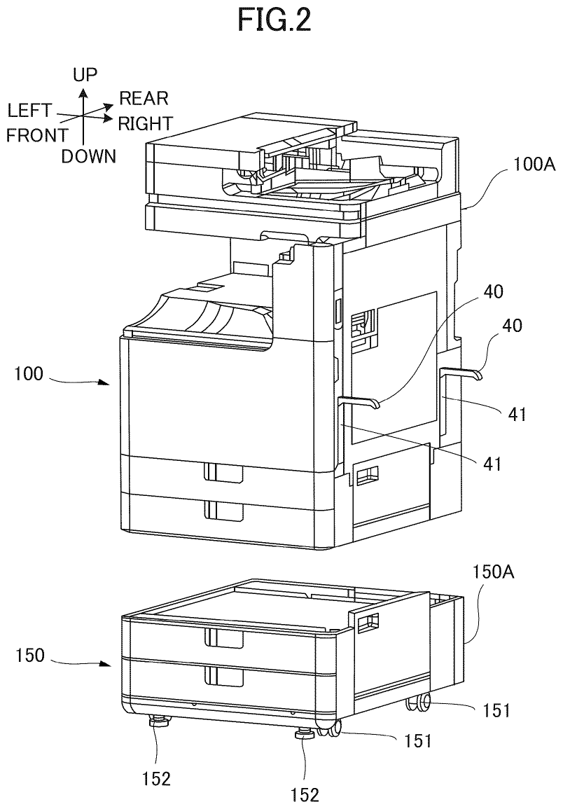

Hereinafter, the present embodiment will be described. First, a schematic configuration of an image forming apparatus 1 will be described with reference to FIGS. 1 and 2. As illustrated in FIGS. 1 and 2, the image forming apparatus 1 in the present embodiment is largely divided into an apparatus body 100 and a sheet feeding apparatus 150. The sheet feeding apparatus 150 is an example of an optional apparatus disposed beneath the apparatus body 100 in a freely detachable manner. As will be described in detail below, the apparatus body 100 is stacked on top of the sheet feeding apparatus 150 in a state where a casing 100A is aligned with a casing 150A of the sheet feeding apparatus 150 in a front-rear direction and a left-right direction. That is, in the present embodiment, the casing 100A and the casing 150A are connected to each other in a vertical direction. Connection in the present embodiment includes a state where the two casings are fixed to each other by welding, screws, or the like and a state where one of the casings is simply placed on the other casing. Hereinafter, as a matter of convenience, a description will be made by using the casing 100A serving as a first casing and the casing 150A serving as a second casing. However, in a case where arrangement of a positioning projection and a positioning member described below is switched, the casing 150A corresponds to the first casing, and the casing 100A corresponds to the second casing.

The terms “front” and “rear” used in the following description mean that a front side of the image forming apparatus 1 is the front and a rear side thereof is the rear. The front side of the image forming apparatus 1 is generally a side in which a user is present when operating the image forming apparatus 1. For example, a side on which an operation panel is disposed or a side on which a cassette 31 storing a recording material is pulled out is the front side. The terms “right” and “left” correspond to sides of those when the image forming apparatus 1 is seen from the front side toward the rear side. In addition, an “up-down direction” is an up-down direction in a state where the image forming apparatus 1 is installed on an installation surface. In general, the “up-down direction” is the same as the vertical direction. FIG. 1 illustrates the image forming apparatus 1 seen from the front side toward the rear side.

The image forming apparatus 1 illustrated in FIG. 1 is a full-color printer of an intermediate transfer type. In the apparatus body 100 of the image forming apparatus 1, for example, the cassette 31, a conveyance path 60, an image forming unit 500, a fixing device 50, a sheet discharge unit 700, a duplex conveyance path 701, various rollers, and the like are installed in the casing 100A. The image forming unit 500 forms a toner image on a recording material S based on an image signal received from a document reading apparatus (not illustrated), an external terminal such as a personal computer, or the like. The image forming unit 500 has four-color image forming portions PY, PM, PC, PK and an intermediate transfer body unit 600. The image forming portions PY, PM, PC, PK respectively form toner images in yellow (Y), magenta (M), cyan (C), and black (K).

A description will be made on a conveying process of the recording material S in the apparatus body 100. The recording materials S are stored to be loaded in one or more (two herein) cassettes 31. The recording materials S are fed one at a time from the cassette 31 to the conveyance path 60 by a feeding roller 31a in accordance with image formation timing. In the present embodiment, the conveyance path 60 is provided along with the recording material S can be conveyed from below to above (a so-called vertical conveyance type). The recording materials S can be any of various types of sheet materials including paper, such as plain paper, heavy paper, rough paper, and uneven paper, a plastic film, and cloth.

The recording material S fed from the cassette 31 to the conveyance path 60 is conveyed to a registration roller pair 42 disposed in the middle of the conveyance path 60. The registration roller pair 42 corrects a skew of the recording material S, and conveys the skew-corrected recording material S to a secondary transfer nip portion formed by a secondary transfer inner roller 22 and a secondary transfer outer roller 44.

A description will be made on an image forming process of the toner image conveyed to the secondary transfer nip portion at the same timing as the conveying process of the recording material S to the secondary transfer nip portion. First, the image forming portions PY to PK will be described. However, the image forming portions PY to PK for the respective colors are basically the same except for toner colors. Thus, a description will hereinafter be made on the yellow image forming portion PY as a representative example.

The image forming portion PY has a photosensitive drum 11Y, a charger 12Y, an exposure device 13Y, and a developing device 14Y. A surface of the photosensitive drum 11Y to be rotationally driven is uniformly charged in advance by the charger 12Y. Thereafter, an electrostatic latent image is formed thereon by a laser beam emitted from the exposure device 13Y driven on the basis of the image signal. Then, the electrostatic latent image formed on the photosensitive drum 11Y is developed into a toner image by the developing device 14Y. The developing device 14Y develops the electrostatic latent image into the toner image by using developer containing toner and carrier. The toner image developed on the photosensitive drum 11Y is applied with a primary transfer voltage by a primary transfer roller 25Y, and is then primarily transferred from the photosensitive drum 11Y to an intermediate transfer belt 21. The primary transfer roller 25Y is disposed to oppose the photosensitive drum 11Y with the intermediate transfer belt 21 being interposed therebetween.

The intermediate transfer belt 21 is an endless belt, is stretched around the secondary transfer inner roller 22, a driving roller 23, a tension roller 24, and the like, and moves in an arrow A direction in FIG. 1. While applying tension to the intermediate transfer belt 21, the tension roller 24 is rotationally driven in conjunction with movement of the intermediate transfer belt 21 by the driving roller 23. The image forming processes for the respective colors processed in parallel by the above-described image forming portions PY to PK for the respective colors are performed at timing of sequentially stacking the color toner images primarily transferred onto the intermediate transfer belt 21 on an upstream side in a moving direction. As a result, a full-color toner image is eventually formed on the intermediate transfer belt 21. The primary transfer rollers 25Y to 25K, the intermediate transfer belt 21, the secondary transfer inner roller 22, the driving roller 23, and the tension roller 24 are integrally configured as the intermediate transfer body unit 600.

With the conveying process and the image forming process each described so far, timing of the recording material S matches timing of the full-color toner image in the secondary transfer nip portion, and the secondary transfer is then performed to transfer the toner image from the intermediate transfer belt 21 onto the recording material S. A predetermined pressure force and a secondary transfer voltage are applied to the recording material S nipped and conveyed to the secondary transfer nip portion. In this way, the toner image is transferred from the intermediate transfer belt 21 onto the recording material S.

The recording material S having the transferred toner image transferred thereon is conveyed along the conveyance path 60 to the fixing device 50, and is then applied with heat and a pressure by the fixing device 50 to fix the toner image onto the recording material S. The fixing device 50 has a fixing roller heated by a heater (not illustrated) and a pressure roller abutting the fixing roller to form a fixing nip portion. The fixing device 50 applies the heat and the pressure to the recording material S passing through the fixing nip portion to fix the toner image onto the recording material S.

The recording material S having the toner image fixed thereon by the fixing device 50 is further conveyed upward along the conveyance path 60, and is discharged to the outside by the sheet discharge unit 700. The sheet discharge unit 700 has a sheet discharge roller 61, and the recording material S is discharged onto a sheet discharge tray 81 by the sheet discharge roller 61. In the present embodiment, in a duplex mode in which images are formed on both sides of the recording material S, in order to form an image on a back surface of the recording material S having the image formed on a front surface thereof, the recording material S is conveyed to the duplex conveyance path 701 to reverse a recording surface thereof. In the duplex mode, the recording material S is conveyed until a trailing edge thereof passes through a flapper 63 by forward rotation of the sheet discharge roller 61. Thereafter, the sheet discharge roller 61 rotates reversely to switch the leading and trailing edges of the recording material S, and the recording material S is conveyed to the duplex conveyance path 701. The recording material S conveyed to the duplex conveyance path 701 returns to the registration roller pair 42. A subsequent conveying process and the image forming process on the back surface are the same as those described above and thus will not be described. The recording material S having the images formed on both of the surfaces is discharged to the outside by the sheet discharge unit 700.

### Sheet Feeding Apparatus

In the sheet feeding apparatus 150, a feeding unit 300 is installed in the casing 150A. The feeding unit 300 has one or more (two herein) cassettes 32 storing the recording materials S, a feeding roller 32a, and the like. The recording materials S are fed one at a time from the cassette 32 to the conveyance path 60 of the apparatus body 100 by the feeding roller 32a in accordance with the image formation timing. Subsequent operations are the same as those described above.

The casing 100A of the apparatus body 100 and the casing 150A of the sheet feeding apparatus 150 are each formed by a front plate provided on the front side, a rear plate provided on the rear side, and highly stiff metal frames such as pillars supporting those, stays connecting those, and beams. The casing 100A and the casing 150A are each covered with a plurality of exterior covers constituting exterior of the image forming apparatus 1. The casing 150A is disposed beneath and to be connectable to the casing 100A.

As illustrated in FIG. 2, the sheet feeding apparatus 150 serving as the optional apparatus is provided to be attachable to/detachable from the apparatus body 100. The sheet feeding apparatus 150 has four casters 151 on a lower surface thereof, and is installed on the installation surface such as a floor. The sheet feeding apparatus 150 also has four height-adjustable legs 152 on the lower surface thereof, and thereby allows the worker to adjust a height of the sheet feeding apparatus 150 to a state where the casters 151 are positioned away from the installation surface.

When the apparatus body 100 is connected to the sheet feeding apparatus 150 set up on the installation surface, a pair of the workers holds grip portions 40 provided on both left and right surfaces of the apparatus body 100 and lifts the apparatus body 100. Each of the grip portions 40 is provided to be pivotable between a first position and a second position. At the first position, the grip portion 40 is stored in a storage portion 41, which is provided to the respective side surface of the apparatus body 100, when not being used by the worker. At the second position illustrated in FIG. 2, the grip portion 40 projects from the respective side surface of the apparatus body 100 such that the grip portion 40 can easily be gripped by the worker when being used by the worker. The workers place the lifted apparatus body 100 on the sheet feeding apparatus 150, and fixedly couple the casing 100A and the casing 150A by using screws (not illustrated) or the like.

Here, since the apparatus body 100 and the sheet feeding apparatus 150 are separate structures, the apparatus body 100 is connected to the sheet feeding apparatus 150 in a state where a relative position between the casing 100A and the casing 150A is adjusted. When the casing 100A and the casing 150A deviate from a predetermined position, for example, the skew of the recording material S to be fed from the sheet feeding apparatus 150 to the conveyance path 60 may be increased to cause jamming of the recording material S in the conveyance path 60, or the registration roller pair 42 may not correct the skew of the recording material S enough to transfer the toner image to a correct position on the recording material S.

In the present embodiment, in order to allow the workers to align the casing 100A and the casing 150A at the predetermined position, one of the casing 100A and the casing 150A has the positioning projections while the other thereof has the positioning holes. In the hitherto known art, in order to fit the positioning projections to the positioning holes, the workers align the casing 100A and the casing 150A at the predetermined position while lifting the heavy apparatus body 100. Such work is fraught with difficulties.

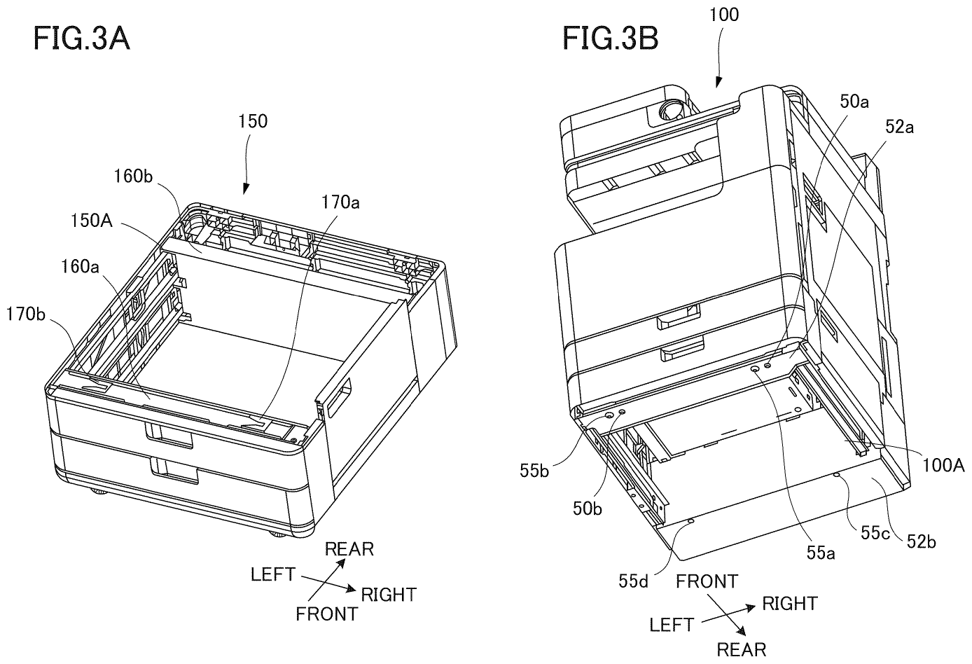

In view of this point, in the present embodiment, the workers first temporarily place the apparatus body 100 on the sheet feeding apparatus 150. Then, the workers slide the temporarily placed apparatus body 100 on the sheet feeding apparatus 150. Such a method enables the alignment of the casing 100A and the casing 150A at the predetermined position without lifting the apparatus body 100. Hereinafter, a description will be made on a configuration achieving such alignment in the present embodiment with reference to FIGS. 3A to 7. It is assumed here that the left-right direction is an attachment direction (a first direction) of the apparatus body 100 to the sheet feeding apparatus 150 and that the front-rear direction is a direction (a second direction) intersecting the vertical direction and the attachment direction. In the following example, the apparatus body 100 is slid from the left to right on the sheet feeding apparatus 150. For this operation, the position of the apparatus body 100 relative to the sheet feeding apparatus 150 at an earlier time point may be referred to as “upstream” while the position of the apparatus body 100 relative to the sheet feeding apparatus 150 at a later time point may be referred to as “downstream”. The expressions “upstream” and “downstream” are also appropriately used for the components provided to the apparatus body 100 and components provided to the sheet feeding apparatus 150.

FIG. 3A is a perspective view illustrating the sheet feeding apparatus 150 seen from above. As illustrated in FIG. 3A, the sheet feeding apparatus 150 has an upper surface front frame 160a and an upper surface rear frame 160b on the upper surface side thereof. The upper surface front frame 160a and the upper surface rear frame 160b each constitute a part of a frame body of the casing 150A. On a front side of a center in the front-rear direction, the upper surface front frame 160a is bridged to left and right frames. On a rear side of the center in the front-rear direction, the upper surface rear frame 160b is bridged to the left and right frames. These upper surface front frame 160a and upper surface rear frame 160b are wide enough in the front-rear direction to place projecting portions 55a, 55b, 55c, 55d thereon. The projecting portions 55a, 55b, 55c, 55d are provided to the apparatus body 100 described below.

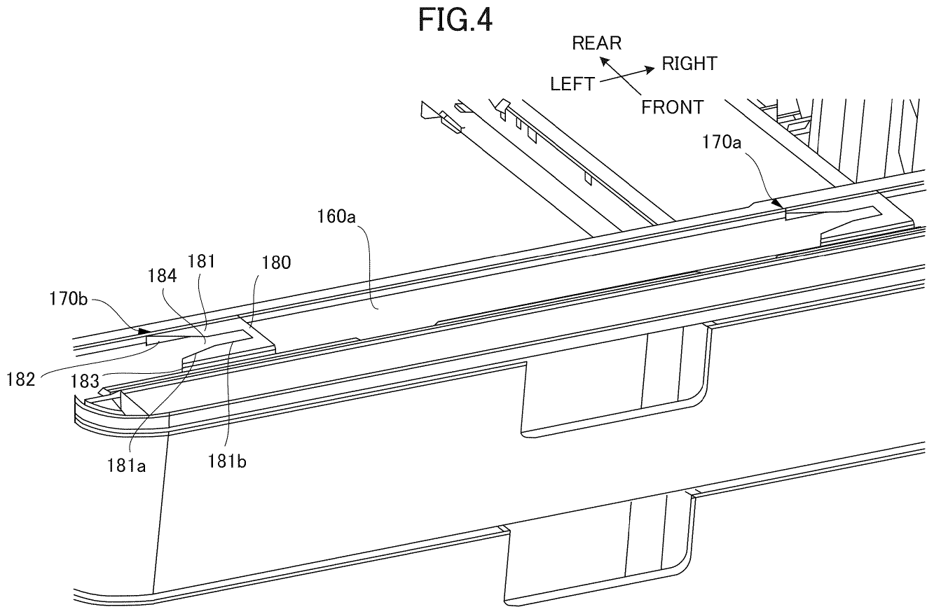

On an upper surface (a second surface) of the upper surface front frame 160a, positioning members 170a, 170b serving as fitted portions are spaced apart in the left-right direction. Positioning projections 50a, 50b (see FIG. 3B) provided to the apparatus body 100 are fitted to the positioning members 170a, 170b, respectively. More specifically, each of the positioning members 170a, 170b has a groove portion extending in the attachment direction. The positioning projections 50a, 50b are fitted to the groove portions. Each of the groove portions has an opening at a first end on the upstream side in the attachment direction such that respective one of the positioning projections 50a, 50b can enter the respective groove portion when the apparatus body 100 and the sheet feeding apparatus 150 are connected to each other. The positioning members 170a, 170b will be described in detail below (see FIG. 4).

FIG. 3B is a perspective view illustrating the apparatus body 100 seen from below. As illustrated in FIG. 3B, the apparatus body 100 has a lower surface front frame 52a and a lower surface rear frame 52b on a lower surface side. The lower surface front frame 52a and the lower surface rear frame 52b each constitute a part of a frame body of the casing 100A. On a front side in the front-rear direction, the lower surface front frame 52a is bridged to left and right frames. On a rear side in the front-rear direction, the lower surface rear frame 52b is bridged to the left and right frames. These lower surface front frame 52a and lower surface rear frame 52b are disposed at positions of opposing the upper surface front frame 160a and the upper surface rear frame 160b of the casing 100A, respectively, in a state where the apparatus body 100 is attached to the sheet feeding apparatus 150.

On a lower surface (a first surface) of the lower surface front frame 52a, the positioning projections 50a, 50b to be respectively fitted to the positioning members 170a, 170b are spaced apart in the left-right direction. The positioning projections 50a, 50b are, for example, cylindrical projecting members projecting downward from the lower surface of the lower surface front frame 52a. On the lower surface of the lower surface front frame 52a, the projecting portions 55a, 55b projecting toward the upper surface front frame 160a below are provided in line with the positioning projections 50a, 50b along the left-right direction. The projecting portions 55a, 55b are respectively provided on the upstream side of the positioning projections 50a, 50b in the attachment direction (from left to right herein) of the apparatus body 100 to the sheet feeding apparatus 150. The projecting portions 55a, 55b are configured to be vertically longer than the positioning projections 50a, 50b. When the apparatus body 100 is temporarily placed on the sheet feeding apparatus 150, the projecting portions 55a, 55b abut the upper surface of the upper surface front frame 160a of the sheet feeding apparatus 150.

Meanwhile, on a lower surface of the lower surface rear frame 52b, similar to the projecting portions 55a, 55b described above, the projecting portions 55c, 55d projecting toward the upper surface rear frame 160b below are spaced apart in the left-right direction. When the apparatus body 100 is temporarily placed on the sheet feeding apparatus 150, the projecting portions 55c, 55d abut an upper surface of the upper surface rear frame 160b of the sheet feeding apparatus 150. These projecting portions 55a, 55b, 55c, 55d are each formed of highly stiff metal or the like not deformed by weight of the apparatus body 100 when abutting respective one of the upper surface front frame 160a and the upper surface rear frame 160b. The three or more projecting portions 55a, 55b, 55c, 55d serving as the supporting portions may be provided to support the apparatus body 100, which is temporarily placed on the sheet feeding apparatus 150, to be slidable without a tilt. The configuration of each of the projecting portions 55a, 55b, 55c, 55d is an exemplary configuration of the supporting portion, and the support structure between the apparatus body 100 and the sheet feeding apparatus 150 is not limited to having these portions. By the way, when the apparatus body 100 is temporarily placed on the sheet feeding apparatus 150, the positioning projections 50a, 50b are not in contact with the upper surface of the upper surface front frame 160a. That is, lower ends (distal ends in a projecting direction) of the positioning projections 50a, 50b in the vertical direction are away from the upper surface of the upper surface front frame 160a.

### Positioning Members

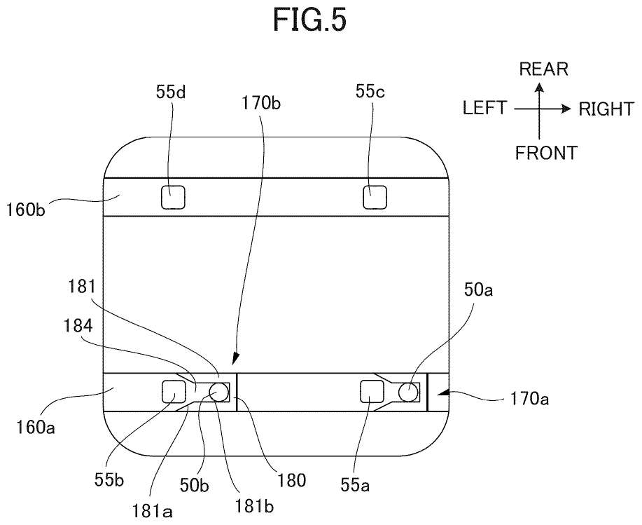

Positioning members 170a, 170b will be described. FIG. 4 is an enlarged view illustrating the positioning members 170a, 170b. FIG. 5 is a schematic view illustrating positions of the positioning members 170a, 170b, the positioning projections 50a, 50b, and the projecting portions 55a to 55d in the state where the apparatus body 100 is attached to the sheet feeding apparatus 150. Since the positioning members 170a, 170b can have the same configuration, a description will hereinafter be made on the positioning member 170b disposed in a left portion of the upper surface front frame 160a as an example.

The positioning member 170b is formed that the positioning projection 50b can enter along the attachment direction (herein, the direction from left to right, an entry direction). As illustrated in FIG. 4, the positioning member 170b has an abutment wall portion 180, a top surface portion 181, a rear wall portion 182, and a front wall portion 183. The positioning member 170b is disposed in a manner to traverse the upper surface of the upper surface front frame 160a in the front-rear direction such that the abutment wall portion 180 is arranged on the downstream side in the attachment direction. The rear wall portion 182 and the front wall portion 183 each extend from the abutment wall portion 180 to the upstream side (the left side) in the attachment direction. At both ends of the abutment wall portion 180 in the front-rear direction, the rear wall portion 182 and the front wall portion 183 are disposed to opposite each other with a spacing therebetween. The top surface portion 181 is disposed on upper ends of the abutment wall portion 180, the rear wall portion 182, and the front wall portion 183. The top surface portion 181 is formed with a notch portion 184 that the positioning projection 50b (see FIG. 3B) of the apparatus body 100 enters when the apparatus body 100 is attached to the sheet feeding apparatus 150. The abutment wall portion 180 is located on the downstream side of the notch portion 184 in the attachment direction. Meanwhile, the upstream side of the notch portion 184 in the attachment direction is open to allow entry of the positioning projection 50b.

As illustrated in FIG. 5, since the top surface portion 181 has the notch portion 184, the top surface portion 181 is formed with a guide portion 181a and a positioning groove portion 181b. When the apparatus body 100 and the sheet feeding apparatus 150 are connected to each other, the positioning projection 50b moves relative to the sheet feeding apparatus 150 in the attachment direction from left to right. The guide portion 181a regulates movement of the moving positioning projection 50b in the direction (the front-rear direction) intersecting the attachment direction. More specifically, a width of the guide portion 181a in the front-rear direction is narrowed from the upstream side toward the downstream side in the attachment direction. With such a configuration, the guide portion 181a guides the positioning projection 50b such that the positioning projection 50b can enter the positioning groove portion 181b. An opening is provided at an upstream end (a left end in the left-right direction, a second end on the opposite side) of the positioning groove portion 181b in the attachment direction. Through the opening, the positioning projection 50b enters the positioning groove portion 181b. A downstream end of the positioning groove portion 181b in the attachment direction (a right end in the left-right direction, a first end) is closed. A width of the positioning groove portion 181b in the front-rear direction (a spacing thereof in the front-rear direction) is almost constant.

Just as described, the top surface portion 181 has the guide portion 181a on the upstream side in the attachment direction and the positioning groove portion 181b located on the downstream side in the attachment direction and continuous with the guide portion 181a. The spacing of the positioning groove portion 181b in the front-rear direction is formed to have a constant width that is substantially the same as a diameter of the positioning projection 50b. Thus, when the positioning projection 50b is fitted to the positioning groove portion 181b, a range of relative movement of the positioning projection 50b to the sheet feeding apparatus 150 in the direction (the front-rear direction) intersecting the attachment direction is limited. The downstream end of the positioning groove portion 181b in the attachment direction (the right end thereof in the left-right direction) is closed. Thus, when the positioning projection 50b abuts the closed end of the positioning groove portion 181b, a range of relative movement of the positioning projection 50b to the sheet feeding apparatus 150 in the attachment direction (the left-right direction) is limited.

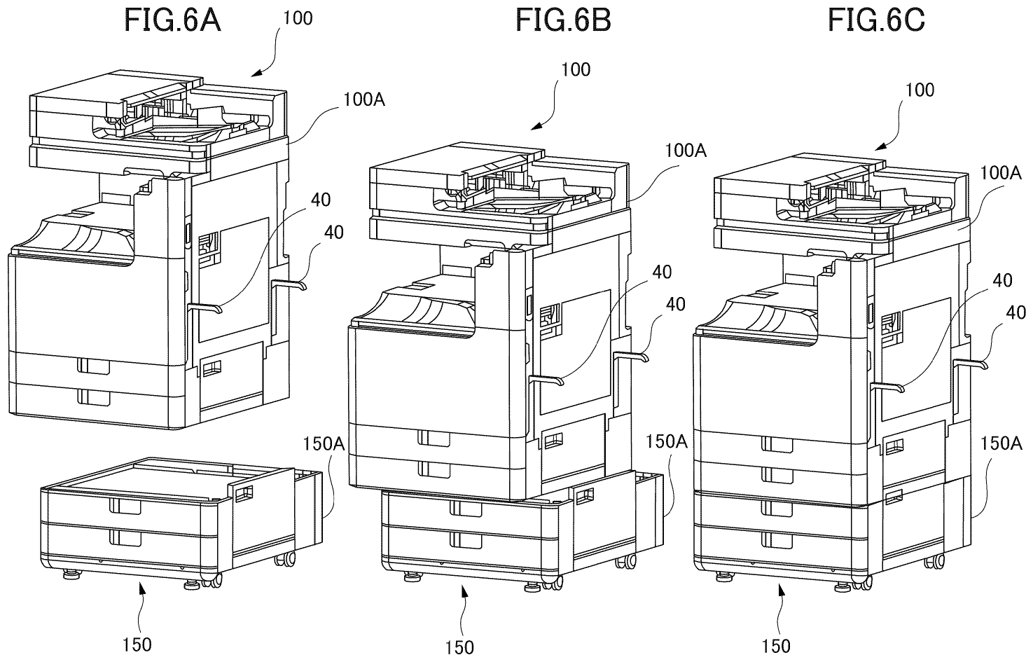

Next, a description will be made on the alignment between the casing 100A of the apparatus body 100 and the casing 150A of the sheet feeding apparatus 150 with reference to FIGS. 3, 4, 5, and 6A to 6C. FIG. 6A illustrates a state before alignment work by the workers, FIG. 6B illustrates a state during the alignment work by the workers, and FIG. 6C illustrates a state after the alignment work by the workers.

As illustrated in FIG. 6A, the workers first grab the grip portions 40 to lift the apparatus body 100, and then move the lifted apparatus body 100 to a position above the sheet feeding apparatus 150. The workers then lower the apparatus body 100 toward the sheet feeding apparatus 150. At this time, as illustrated in FIG. 6B, the apparatus body 100 is lowered and temporarily placed at a position shifted to the left from an original attachment position with respect to the sheet feeding apparatus 150. In the present embodiment, the casing 100A and the casing 150A are temporarily placed in a misaligned state such that the right side of the apparatus body 100 overlaps a projection plane of the sheet feeding apparatus 150 when seen from above. This is suitable when the sheet discharge unit 700 and the duplex conveyance path 701, which are heavier than the other components, are installed vertically in the right portion of the casing 100A (see FIG. 1), and a center of gravity of the apparatus body 100 tends to lean to the right side. That is, the workers can temporarily place the comparatively heavy right portion of the apparatus body 100 on the sheet feeding apparatus 150 beforehand.

While the apparatus body 100 is temporarily placed on the sheet feeding apparatus 150, the projecting portions 55a, 55b, 55c, 55d of the apparatus body 100 are placed on the upper surface front frame 160a and the upper surface rear frame 160b of the sheet feeding apparatus 150, respectively. On the upper surface front frame 160a, the projecting portions 55a, 55b are placed on the upstream side of the positioning members 170a, 170b in the attachment direction, respectively. Just as described, in the present embodiment, the upper surface front frame 160a and the upper surface rear frame 160b have abutment surfaces for temporary placement of the projecting portions 55a, 55b, 55c, 55d.

In the state where the apparatus body 100 is temporarily placed as illustrated in FIG. 6B, the positioning projections 50a, 50b are not fitted to the positioning members 170a, 170b, respectively. Accordingly, in order to respectively fit the positioning projections 50a, 50b to the positioning members 170a, 170b, the workers slide the apparatus body 100 from left to right while the apparatus body 100 is temporarily placed on the sheet feeding apparatus 150, that is, while the projecting portions 55a, 55b, 55c, 55d are in abutment with the upper surface front frame 160a and the upper surface rear frame 160b, respectively.

As the apparatus body 100 is slid, the positioning projections 50a, 50b respectively enter the notch portions 184 of the positioning members 170a, 170b. More precisely, each of the positioning projections 50a, 50b first enters the guide portion 181a of the respective notch portion 184. The apparatus body 100 is slid from left to right while the movement thereof in the front-rear direction is regulated by the notch portions 184 of the positioning members 170a, 170b via the positioning projections 50a, 50b. As described above, in each of the positioning members 170a, 170b, the width in the front-rear direction of the guide portion 181a of the top surface portion 181 is gradually narrowed from the upstream side toward the downstream side in the attachment direction (see FIG. 5). Accordingly, even in a case where relative positions of the positioning projections 50a, 50b to the positioning members 170a, 170b in the front-rear direction slightly deviate during the temporary placement of the apparatus body 100, the workers can easily make the positioning projections 50a, 50b enter the notch portions 184 of the positioning members 170a, 170b, respectively.

Each of the positioning projections 50a, 50b are first guided by the guide portion 181a of the respective notch portion 184, and then reaches the opening of the respective positioning groove portion 181b. Thereafter, each of the positioning projections 50a, 50b moves along the respective positioning groove portion 181b. Then, the apparatus body 100 is slid until the positioning projections 50a, 50b respectively abut the abutment wall portions 180 (the closed ends of the positioning groove portions 181b) of the positioning members 170a, 170b. When the positioning projections 50a, 50b abut the abutment wall portions 180 and are fitted to the positioning members 170a, 170b, respectively, the casing 100A and the casing 150A are aligned at a position illustrated in FIG. 6C. After the alignment between the casing 100A and the casing 150A, the workers fix the casing 100A to the casing 150A by the screws (not illustrated) or the like.

Here, in the present embodiment, the two positioning members 170a, 170b are provided. In order to align the casing 100A and the casing 150A, at least one pair of the positioning projection 50a and the positioning member 170a is required. Thus, the positioning member 170b may not be provided. The positioning member 170b, which is provided on the upstream side in the attachment direction, also functions as a rotation regulation member. In the state where the apparatus body 100 is attached to the sheet feeding apparatus 150, the rotation regulation member regulates rotation of the casing 100A with respect to the casing 150A about the positioning projection 50a fitted to the positioning member 170a on the downstream side in the attachment direction. Just as described, the casing 100A and the casing 150A can easily be aligned in a rotational direction by adding the positioning member 170b.

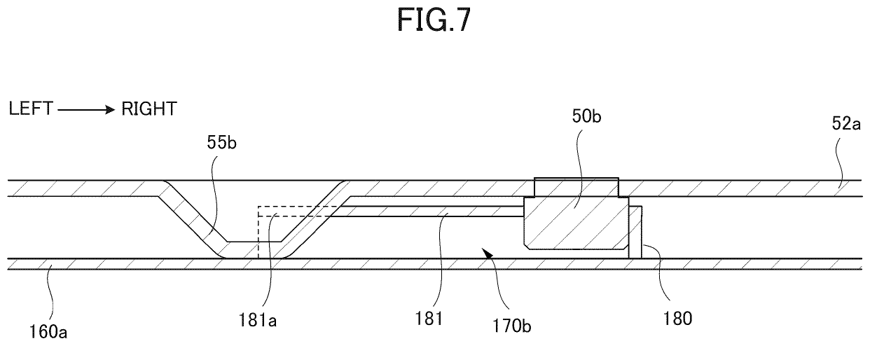

As illustrated in FIG. 7, the positioning projection 50b is provided to project from the lower surface (the first surface) of the lower surface front frame 52a opposing the upper surface front frame 160a toward the upper surface front frame 160a. On the upper surface (the second surface) of the upper surface front frame 160a opposing the lower surface of the lower surface front frame 52a, the top surface portion 181 of the positioning member 170b is provided at a position closer to the lower surface of the lower surface front frame 52a than the upper surface of the upper surface front frame 160a. Then, when the positioning projection 50b is in abutment with the abutment wall portion 180, a part of the projecting portion 55b may enter the notch portion 184 of the positioning member 170b, in other words, a part on the downstream side in the attachment direction of the projecting portion 55b seen in the front-rear direction may overlap the guide portion 181a of the top surface portion 181. In a case where an unintended large force is applied to the apparatus body 100 in the front-rear direction before the casing 100A is fixed to the casing 150A, the positioning projection 50b (50a) possibly breaks. Thus, breakage of the positioning projection 50b (50a) is prevented by making the part of the projecting portion 55b (55a) enter the notch portion 184.

As it has been described so far, in the present embodiment, the casing 150A of the sheet feeding apparatus 150 has the positioning members 170a, 170b, and the casing 100A of the apparatus body 100 has the positioning projections 50a, 50b. The positioning members 170a, 170b are formed such that the positioning projections 50a, 50b enter and are fitted to the positioning members 170a, 170b, respectively, as the apparatus body 100 is slid on the sheet feeding apparatus 150 in the attachment direction of the apparatus body 100 to the sheet feeding apparatus 150. When the positioning projections 50a, 50b are fitted to the positioning members 170a, 170b, respectively, the casing 100A and the casing 150A are aligned with each other. That is, the simple configuration can be adopted that, when the apparatus body 100 is attached to the sheet feeding apparatus 150, the workers temporarily place the apparatus body 100 on the sheet feeding apparatus 150, slide the temporarily-placed apparatus body 100 on the sheet feeding apparatus 150, and thereby align the casing 100A and the casing 150A. In this way, since the workers temporarily place the apparatus body 100 on the sheet feeding apparatus 150, the workers do not have to keep the apparatus body 100 in the lifted state. Thus, it is possible to reduce a burden at the time of attaching the apparatus body 100, more specifically, a burden of aligning the casing 100A and the casing 150A.

The guide portion 181a in the above-described embodiment may not be provided. Since the positioning projection 50b is fitted to the positioning groove portion 181b, there is a limited degree of freedom in the relative movement of the positioning projection 50b to the sheet feeding apparatus 150 (the casing 150A). More specifically, in the first direction (the left-right direction in the above-described example) intersecting the vertical direction, the positioning projection 50b is allowed to move relative to the sheet feeding apparatus 150 (the casing 150A). Meanwhile, in the second direction (the front-rear direction in the above-described example) intersecting both the vertical direction and the first direction, the range of the relative movement of the positioning projection 50b to the sheet feeding apparatus 150 (the casing 150A) is limited. With such a configuration, an effect of reducing the burden of aligning the casing 100A and the casing 150A described above can sufficiently be exerted. It is considered that absence of the guide portion 181a may cause some difficulty in making the positioning projection 50b enter the positioning groove portion 181b. However, since this work is performed by sliding the temporarily-placed apparatus body 100 on the sheet feeding apparatus 150, the alignment can still be performed more easily than that in the hitherto known art.

In the case of the above-described embodiment, although not illustrated, for example, a height-adjustable member similar to the height-adjustable leg 152 (see FIG. 2) of the sheet feeding apparatus 150 may be detachably provided to a lower surface of the apparatus body 100. When using the apparatus body 100 by itself, the worker attaches the height-adjustable members to four corners of the lower surface of the apparatus body 100. Then, the worker adjusts a distance between the installation surface and the lower surface of the apparatus body 100 such that the positioning projections 50a, 50b and the projecting portions 55a to 55d do not contact the installation surface, and thereby adjusts a height of the lower surface of the apparatus body 100 from the installation surface by the height-adjustable member.

In the above-described embodiment, the casing 150A of the sheet feeding apparatus 150 has the positioning members 170a, 170b, and the casing 100A of the apparatus body 100 has the positioning projections 50a, 50b and the projecting portions 55a to 55d. However, the present disclosure is not limited thereto. The casing 100A of the apparatus body 100 may have the positioning members 170a, 170b, and the casing 150A of the sheet feeding apparatus 150 may have the positioning projections 50a, 50b and the projecting portions 55a to 55d.

### Other Embodiments

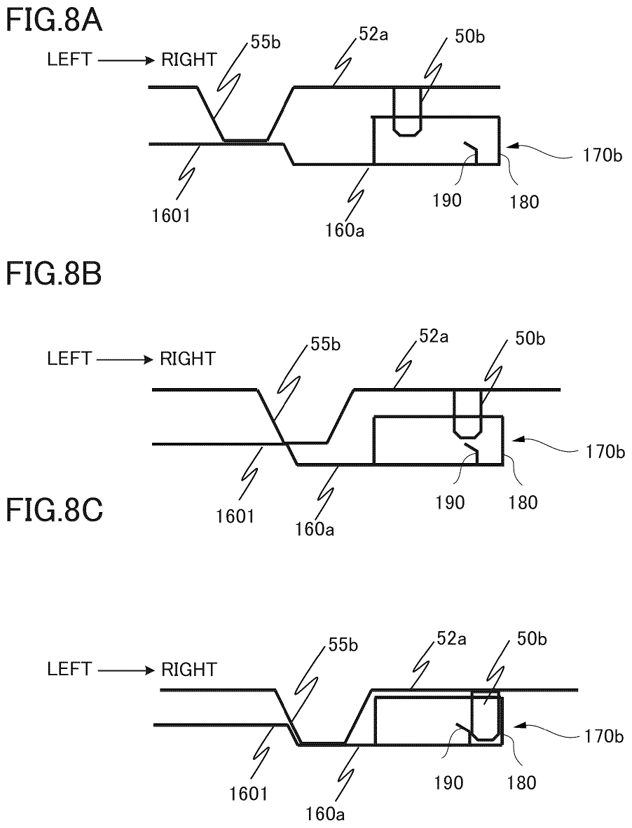

In the above-described embodiment, for example, as illustrated in FIGS. 3A and 7, the upper surface of the upper surface front frame 160a and the upper surface of the upper surface rear frame 160b abutted by the projecting portions 55a, 55b, 55c, 55d, respectively, are each formed to be the flat surface but are not limited thereto. The upper surface of the upper surface front frame 160a and the upper surface of the upper surface rear frame 160b may not be the flat surfaces, and at least one thereof may be formed with a projecting portion 1601 as illustrated in FIGS. 8A to 8C. FIGS. 8A to 8C each illustrate the projecting portion 1601 (a second projecting portion) formed on the upper surface of the upper surface front frame 160a in a manner to correspond to the projecting portion 55b (a first projecting portion) of the lower surface front frame 52a.

The projecting portion 55b is provided to the lower surface front frame 52a and projects more toward the upper surface of the upper surface front frame 160a than the lower surface of the lower surface front frame 52a. The projecting portion 1601 is provided to the upper surface front frame 160a and projects more toward the lower surface of the lower surface front frame 52a than the upper surface of the upper surface front frame 160a. Although not illustrated, in addition to the projecting portion 1601, the upper surface of the upper surface front frame 160a is formed with another projecting portion corresponding to the projecting portion 55a of the lower surface front frame 52a in a similar manner to the projecting portion 1601.

In a case where the apparatus body 100 is temporarily placed on the sheet feeding apparatus 150, and the casing 100A is located at a first position with respect to the casing 150A in the attachment direction, as illustrated in FIG. 8A, the projecting portion 55b abuts the projecting portion 1601 one step higher than the upper surface of the upper surface front frame 160a. However, the positioning projection 50b is not fitted to the positioning member 170b. Then, when the apparatus body 100, which is temporarily placed on the sheet feeding apparatus 150, is slid from left to right, the apparatus body 100 goes through a state immediately before the abutment between the projecting portion 55b and the projecting portion 1601 is canceled as illustrated in FIG. 8B, and is then dropped on the sheet feeding apparatus 150 side. Thereafter, when the casing 100A is located at a second position on the downstream side of the first position with respect to the casing 150A in the attachment direction, as illustrated in FIG. 8C, the projecting portion 55b and the projecting portion 1601 do not abut each other, but the positioning projection 50b is fitted to the positioning member 170b.

The positioning member 170b has a stopper member 190 serving as a regulation member, and the stopper member 190 has a spacing on the upstream side of the abutment wall portion 180 in the attachment direction to allow the positioning projection 50b to be fitted between the stopper member 190 and the abutment wall portion 180. When the apparatus body 100 is dropped on the sheet feeding apparatus 150 side, the positioning projection 50b enters the spacing between the stopper member 190 and the abutment wall portion 180 diagonally downward from the left. In a state of abutting the abutment wall portion 180, the movement of the positioning projection 50b in the attachment direction is regulated by the abutment wall portion 180 while the movement thereof in an opposite direction (from right to left) to the attachment direction is regulated by the stopper member 190. In addition, in a state of not abutting the projecting portion 1601, the movement of the projecting portion 55b in the opposite direction to the attachment direction is regulated by the projecting portion 1601. In this way, even in a case where the unintended large force is applied to the apparatus body 100 in the left-right direction before the casing 100A is fixed to the casing 150A by the screws or the like, the aligned casing 100A and casing 150A are not misaligned.

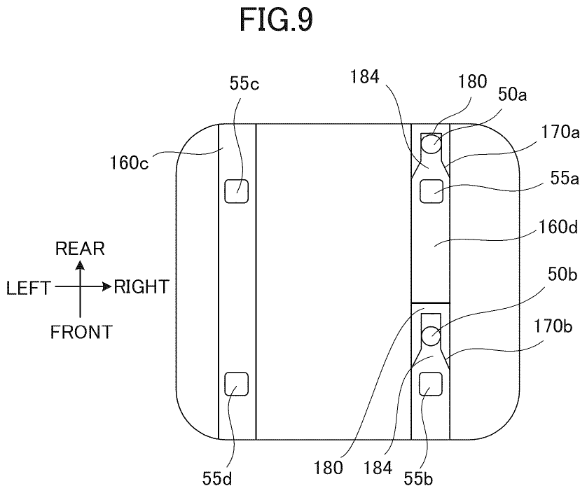

In the above-described embodiment, as illustrated in FIGS. 3A and 3B, the upper surface front frame 160a has the positioning members 170a, 170b, the lower surface front frame 52a has the positioning projections 50a, 50b and the projecting portions 55a, 55b, and the lower surface rear frame 52b has the projecting portions 55c, 55d. This is an example of the case where the attachment direction of the apparatus body 100 to the sheet feeding apparatus 150 is “left to right” as described above. Meanwhile, in a case where a driving unit, electrical components, and the like (not illustrated) that are heavier than the other components are installed in a rear portion of the casing 100A, for example, the attachment direction of the apparatus body 100 to the sheet feeding apparatus 150 may be “from front to rear”. FIG. 9 is a schematic view illustrating the positioning members 170a, 170b, the positioning projections 50a, 50b, and the projecting portions 55a, 55b, 55c, 55d when the attachment direction is “from front to rear”.

When the attachment direction of the apparatus body 100 to the sheet feeding apparatus 150 is “front to rear”, as illustrated in FIG. 9, the positioning members 170a, 170b are provided on a surface of an upper surface right frame 160d of the casing 150A. Meanwhile, the positioning projections 50a, 50b and the projecting portions 55a, 55b are provided on a surface of a lower surface right frame (not illustrated) of the casing 100A. In addition, the projecting portions 55c, 55d are provided on a surface of a lower surface left frame (not illustrated) of the casing 100A.

The sheet feeding apparatus 150 has, on the upper surface side thereof, the upper surface right frame 160d and an upper surface left frame 160c each constituting a part of the frame body of the casing 150A. On the right side of a center in the left-right direction, the upper surface right frame 160d is bridged to front and rear frames. On the left side of the center in the left-right direction, the upper surface left frame 160c is bridged to the front and rear frames. Although not illustrated, the apparatus body 100 has, on the lower surface side thereof, the lower surface right frame and the lower surface left frame each constituting a part of the frame body of the casing 100A. On the right side in the left-right direction, the lower surface right frame is bridged to front and rear frames. On the left side in the left-right direction, the lower surface left frame is bridged to the front and rear frames. These lower surface right frame and lower surface left frame are disposed at positions respectively opposing the upper surface right frame 160d and the upper surface left frame 160c of the sheet feeding apparatus 150 in the state where the apparatus body 100 is attached to the sheet feeding apparatus 150.

In a case where the attachment direction of the apparatus body 100 is “front to rear”, the casing 100A and the casing 150A are temporarily placed in a misaligned state such that the rear side of the apparatus body 100 overlaps the projection plane of the sheet feeding apparatus 150 when seen from above. This is suitable when the driving unit, the electrical components, and the like (not illustrated), which are heavier than the other components, are installed in the rear portion of the casing 100A, and thus the center of gravity of the apparatus body 100 tends to lean to the rear side.

In the state where the apparatus body 100 is temporarily placed, the positioning projections 50a, 50b are not fitted to the positioning members 170a, 170b, respectively. Accordingly, in order to respectively fit the positioning projections 50a, 50b to the positioning members 170a, 170b, the workers slide the apparatus body 100 from front to rear while the apparatus body 100 is temporarily placed on the sheet feeding apparatus 150, that is, while the projecting portions 55a, 55b, 55c, 55d are in abutment with the upper surface right frame 160d and the upper surface left frame 160c, respectively. As this sliding of the apparatus body 100, the positioning projections 50a, 50b respectively enter the notch portions 184 of the positioning members 170a, 170b.

In a case of the example illustrated in FIG. 9, the apparatus body 100 is slid until the positioning projection 50a abuts the abutment wall portion 180 of the positioning member 170a. When the positioning projection 50a abuts and is fitted to the abutment wall portion 180 of the positioning member 170a, the casing 100A and the casing 150A are aligned with each other. Here, the positioning projection 50b may not abut the abutment wall portion 180 of the positioning member 170b. That is, in a state where the positioning projection 50a abuts a first end of the positioning groove portion 181b of the positioning member 170a, the positioning projection 50b may be located away from both ends (the first end has the opening, and a second end is closed) of the positioning groove portion 181b of the positioning member 170b. The positioning member 170b only needs to regulate the rotation of the casing 100A with respect to the casing 150A about the positioning projection 50a fitted to the positioning member 170a in the state where the apparatus body 100 is attached to the sheet feeding apparatus 150.

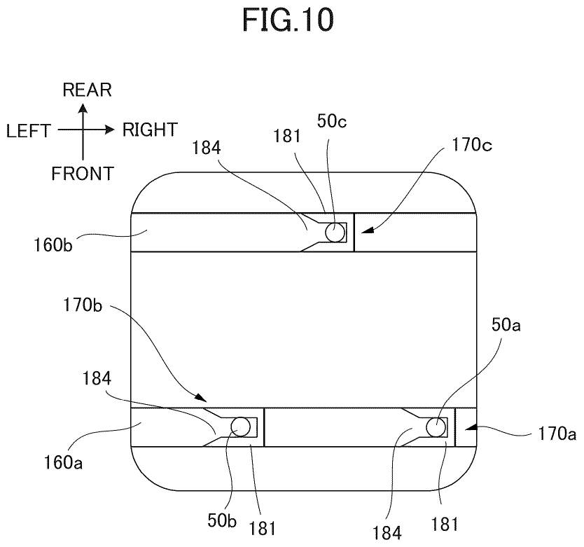

In the above-described embodiment, the configuration including the projecting portions 55a, 55b, 55c, 55d is described. However, depending on a case, a configuration that does not include the projecting portions 55a, 55b, 55c, 55d may be adopted. FIG. 10 is a schematic view illustrating the positioning members 170a, 170b, 170c and the positioning projections 50a, 50b, 50c in the configuration not including the projecting portion. A description will be made with reference to FIGS. 3A, 3B, and 10. Here, the attachment direction of the apparatus body 100 is “from left to right”.

Similar to the above-described embodiment, the positioning members 170a, 170b are provided to the upper surface front frame 160a of the casing 150A. In addition, as illustrated in FIG. 10, the different positioning member 170c from those is provided to the upper surface rear frame 160b of the casing 150A. These positioning members 170a, 170b, 170c are each formed of the highly stiff metal or the like. Similar to the above-described embodiment, the positioning projections 50a, 50b are provided to the lower surface front frame 52a of the casing 100A. In addition, the positioning projection 50c to be fitted to the positioning member 170c is provided to the lower surface rear frame 52b. These lower surface front frame 52a and lower surface rear frame 52b do not have the projecting portions 55a, 55b, 55c, 55d.

In a case where the projecting portions 55a, 55b, 55c, 55d are not provided, and the apparatus body 100 is temporarily placed on the sheet feeding apparatus 150, the lower surface front frame 52a is placed on the top surface portions 181 of the positioning members 170a, 170b, and the lower surface rear frame 52b is placed on the top surface portion 181 of the positioning member 170c. In order to fit the positioning projections 50a, 50b, 50c to the positioning members 170a, 170b, 170c, respectively, the workers slide the apparatus body 100 from left to right while the apparatus body 100 is temporarily placed on the sheet feeding apparatus 150, that is, while the top surface portions 181 of the positioning members 170a, 170b, 170c are in abutment with the lower surface front frame 52a and the lower surface rear frame 52b, respectively. In this case, in the positioning members 170a, 170b, 170c, the top surface portions 181 respectively abut the lower surface of the lower surface front frame 52a and the lower surface of the lower surface rear frame 52b, and serve as supporting surfaces capable supporting the casing 100A on the casing 150A. Then, the positioning projections 50a, 50b, 50c enter and are fitted to the notch portions 184 of the positioning members 170a, 170b, 170c, respectively, according to the sliding movement of the apparatus body 100. In this way, the casing 100A and the casing 150A are aligned with each other.

The three or more positioning members 170a, 170b, 170c may be provided to slidably support the temporarily-placed apparatus body 100 without the tilt. When the three positioning members 170a, 170b, 170c are provided as described above, the positioning member 170c may be disposed between the positioning member 170a and the positioning member 170b in the left-right direction when seen from the front.

In the above-described embodiment, the description has been made on the case where two structures of the apparatus body 100 and the sheet feeding apparatus 150 are stacked vertically and attached to each other as the example. When there are the three or more structures, a similar effect can be exerted by adopting the above-described embodiment for the structures in the vertically stacked and attached relationship. For example, the above-described embodiment can also be adopted for a case where a document reading apparatus is detachably provided over the apparatus body 100.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-154760, filed Sep. 9, 2024, which is hereby incorporated by reference herein in its entirety.

What is claimed is:

1. An image forming apparatus configured to form an image on a recording material, the image forming apparatus comprising:
a first casing;
a second casing connected to the first casing in a vertical direction;
a positioning projection provided to the first casing; and
a fitted portion provided to the second casing, the positioning projection fitting to the fitted portion,
wherein the fitted portion is formed to allow relative sliding movement between the positioning projection and the second casing in a first direction intersecting the vertical direction and to limit a range of relative movement between the positioning projection and the second casing in a second direction intersecting the vertical direction and the first direction when the first casing and the second casing being connected to each other.

2. The image forming apparatus according to claim 1,
wherein the fitted portion includes a groove portion that extends in the first direction and into which the positioning projection is inserted.

3. The image forming apparatus according to claim 2,
wherein the fitted portion is configured such that the positioning projection abuts a first end of the groove portion in the first direction so that a range of relative movement between the positioning projection and the second casing in the first direction is limited.

4. The image forming apparatus according to claim 2,
wherein a first end of the groove portion in the first direction includes an opening configured to allow the positioning projection to enter the groove portion along the first direction when the first casing and the second casing are connected to each other.

5. The image forming apparatus according to claim 2,
wherein the fitted portion is configured such that the positioning projection abuts a first end of the groove portion in the first direction so that a range of relative movement between the positioning projection and the second casing in the first direction is limited, and
wherein a second end on an opposite side from the first end of the groove portion in the first direction includes an opening configured to allow the positioning projection to enter the groove portion along the first direction when the first casing and the second casing are connected to each other.

6. The image forming apparatus according to claim 5 further comprising:
a guide portion configured to guide the positioning projection to the opening of the groove portion by limiting a relative position of the positioning projection to the second casing in the second direction when the first casing and the second casing are connected to each other.

7. The image forming apparatus according to claim 6,
wherein a spacing of the guide portion in the second direction is narrowed from an upstream side to a downstream side along an entry direction of the positioning projection when the first casing and the second casing are connected to each other.

8. The image forming apparatus according to claim 1 further comprising:
a second positioning projection provided to the first casing; and
a second fitted portion provided to the second casing and configured to be fitted to the second positioning projection,
wherein the second fitted portion is configured to allow relative sliding movement between the second positioning projection and the second casing in the first direction and to limit a range of relative movement between the second positioning projection and the second casing in the second direction when the first casing and the second casing are connected to each other.

9. The image forming apparatus according to claim 8,
wherein the fitted portion includes a first groove portion that extends in the first direction and in which the positioning projection is inserted,
wherein the second fitted portion includes a second groove portion that extends in the first direction and in which the second positioning projection is inserted,
wherein the fitted portion is configured such that the positioning projection abuts a first end of the first groove portion in the first direction so that a range of relative movement between the positioning projection and the second casing in the first direction is limited, and
wherein in a state where the positioning projection abuts the first end of the first groove portion, the second positioning projection is located away from both ends of the second groove portion in the first direction.

10. The image forming apparatus according to claim 2,
wherein the positioning projection projects from a first surface of the first casing toward the second casing, the first surface opposing the second casing, and
wherein the fitted portion includes a top surface portion provided to a second surface of the second casing opposing the first surface, formed with the groove portion, and disposed at a position closer to the first surface than the second surface.

11. The image forming apparatus according to claim 1 further comprising:
a supporting portion provided to one of the first casing and the second casing and configured to abut the other of the first casing and the second casing,
wherein the positioning projection projects from a first surface of the first casing toward the second casing, the first surface opposing the second casing,
wherein the supporting portion is longer than the positioning projection in the vertical direction, and
wherein a distal end of the positioning projection in a projecting direction is located away from a second surface of the second casing opposing the first surface.

12. The image forming apparatus according to claim 1,
wherein the positioning projection projects from a first surface of the first casing toward the second casing, the first surface opposing the second casing, and
wherein the fitted portion includes a supporting surface configured to abut the first surface and to support the first casing on the second casing.

13. The image forming apparatus according to claim 1,
wherein the first casing is connected onto the second casing in the vertical direction.

14. The image forming apparatus according to claim 1,
wherein the first casing is connected to a bottom of the second casing in the vertical direction.

15. An image forming apparatus configured to form a toner image on a recording material, the image forming apparatus comprising:
a first casing;
a second casing connected to the first casing in a vertical direction;
a positioning projection provided to a first surface of the first casing;
a fitted portion provided to a second surface of the second casing and configured to be fitted to the positioning projection, the second surface opposing the first surface;
a first projecting portion provided to the first casing and projecting more toward the second surface than the first surface; and
a second projecting portion provided to the second casing and projecting more toward the first surface than the second surface,
wherein the fitted portion is formed to allow relative movement between the positioning projection and the second casing in a first direction intersecting the vertical direction and to limit a range of relative movement between the positioning projection and the second casing in a second direction intersecting the vertical direction and the first direction when the first casing and the second casing are connected to each other, and
Wherein, when the first casing and the second casing are connected,
in a case where the first casing is located at a first position with respect to the second casing in the first direction, the first projecting portion and the second projecting portion abut each other, and the positioning projection is not fitted to the fitted portion, and
in a case where the first casing is located at a second position on a downstream side of the first position with respect to the second casing in the first direction, the first projecting portion and the second projecting portion do not abut each other, and the positioning projection is fitted to the fitted portion.

16. The image forming apparatus according to claim 15, wherein
the fitted portion includes a regulation member configured to regulate movement of the positioning projection in an opposite direction to the first direction when the first casing is located at the second position and the positioning projection is fitted to the fitted portion.

17. The image forming apparatus according to claim 15,
wherein the fitted portion includes a groove portion that extends in the first direction and in which the positioning projection is inserted,
wherein the fitted portion is configured such that the positioning projection abuts a first end of the groove portion in the first direction so that a range of the relative movement between the positioning projection and the second casing in the first direction is limited, and
wherein a second end on an opposite side from the first end of the groove portion in the first direction includes an opening configured to allow the positioning projection to enter the groove portion along the first direction when the first casing and the second casing are connected to each other.

18. The image forming apparatus according to claim 17 further comprising:
a guide portion configured to guide the positioning projection to the opening of the groove portion by limiting a relative position of the positioning projection to the second casing in the second direction when the first casing and the second casing are connected to each other.

19. The image forming apparatus according to claim 18,
wherein a spacing of the guide portion in the second direction is narrowed from an upstream side to a downstream side along an entry direction of the positioning projection when the first casing and the second casing are connected to each other.

20. An image forming apparatus configured to form an image on a recording material, the image forming apparatus comprising:
a first casing;
a second casing connected to the first casing in a vertical direction;
a positioning projection provided to the first casing; and
a fitted portion provided to the second casing, the positioning projection fitting to the fitted portion,
wherein the fitted portion includes a groove portion that extends in the first direction intersecting the vertical direction and into which the positioning projection is inserted.

21. The image forming apparatus according to claim 20,
wherein, in a state where the positioning projection is inserted in the groove portion, the positioning projection is relatively movable with respect to the second casing in the first direction at least in a first range,
wherein, in a state where the positioning projection is inserted in the groove portion, a relative movement of the positioning projection with respect to the second casing in a second direction intersecting the vertical direction and the first direction is limited within a second range, and
wherein the first range is broader than the second range.

22. The image forming apparatus according to claim 20,
wherein the fitted portion is configured such that the positioning projection abuts a first end of the groove portion in the first direction so that a range of relative movement between the positioning projection and the second casing in the first direction is limited, and
wherein a second end on an opposite side from the first end of the groove portion in the first direction includes an opening configured to allow the positioning projection to enter the groove portion along the first direction when the first casing and the second casing being connected to each other.
